(19) United States
(12) Patent Application Publication
(10) Pub. No.: US 2014/0317926 A1
(43) Pub. Date: Oct. 30, 2014

(54) FRONT CENTERBODY SUPPORT FOR A GAS TURBINE ENGINE

(71) Applicant: United Technologies Corporation, Hartford, CT (US)

(72) Inventors: Todd A. Davis, Tolland, CT (US); Brian P. Cigal, Windsor, CT (US)

(21) Appl. No.: 14/325,071

(22) Filed: Jul. 7, 2014

Related U.S. Application Data
(62) Division of application No. 13/087,579, filed on Apr. 15, 2011.

(51) Int. Cl. F02C 7/20

(52) U.S. Cl. CPC F02C 7/20
USPC 29/889.2

(57) ABSTRACT

A method for maintaining a gas turbine engine includes providing access from a forward section of a front center body assembly to a flex support mounted to a front center body support. The flex support is mounted to a geared architecture.

### CROSS-REFERENCE TO RELATED APPLICATIONS

This disclosure is a divisional of U.S. patent application Ser. No. 13/087,579 filed Apr. 15, 2011.

### BACKGROUND

The present disclosure relates to a gas turbine engine, and in particular, to a case structure therefor.

Gas turbine engines typically include one or more rotor shafts that transfer power and rotary motion from a turbine section to a compressor section and fan section. The rotor shafts are supported within an engine static structure which is typically constructed of modules with individual case sections which are joined together at bolted flanges. The flanges form a joint capable of withstanding the variety of loads transmitted through the engine static structure.

### SUMMARY

In one exemplary embodiment, a method for maintaining a gas turbine engine includes providing access from a forward section of a front center body assembly to a flex support mounted to a front center body support. The flex support is mounted to a geared architecture.

In a further embodiment of any of the above, the method includes interconnecting a fan of the gas turbine engine to the geared architecture.

In a further embodiment of any of the above, the method includes disassembling the geared architecture and the fan as a unit.

In a further embodiment of any of the above, the method includes removing a multiple of fasteners located from the front center body assembly through the forward section.

In a further embodiment of any of the above, the method includes locating the multiple of fasteners to provide access from the forward section of the front center body assembly opposite a bearing package.

In a further embodiment of any of the above, the method includes assembling the geared architecture and the fan as a unit.

In a further embodiment of any of the above, the method includes inserting a multiple of fasteners into the front center body assembly through the forward section.

In a further embodiment of any of the above, the method includes assembling the multiple of fasteners to a fastener flange of the flex support and a front center body section of the front center body support.

In a further embodiment of any of the above, the method includes locating the flex support at least partially within the front center body support at a splined interface.

### BRIEF DESCRIPTION OF THE DRAWINGS

Various features will become apparent to those skilled in the art from the following detailed description of the disclosed non-limiting embodiment. The drawings that accompany the detailed description can be briefly described as follows:

FIG. 1 is a schematic cross-section of a gas turbine engine;

FIG. 2 is an enlarged cross-section of a sectional of the gas turbine engine which illustrates a front center body assembly;

FIG. 3 is an enlarged perspective partial cross-section of a front center body support of the front center body assembly; and

FIG. 4 is an enlarged sectional view of the front center body support and flexible support mounted therein.

### DETAILED DESCRIPTION

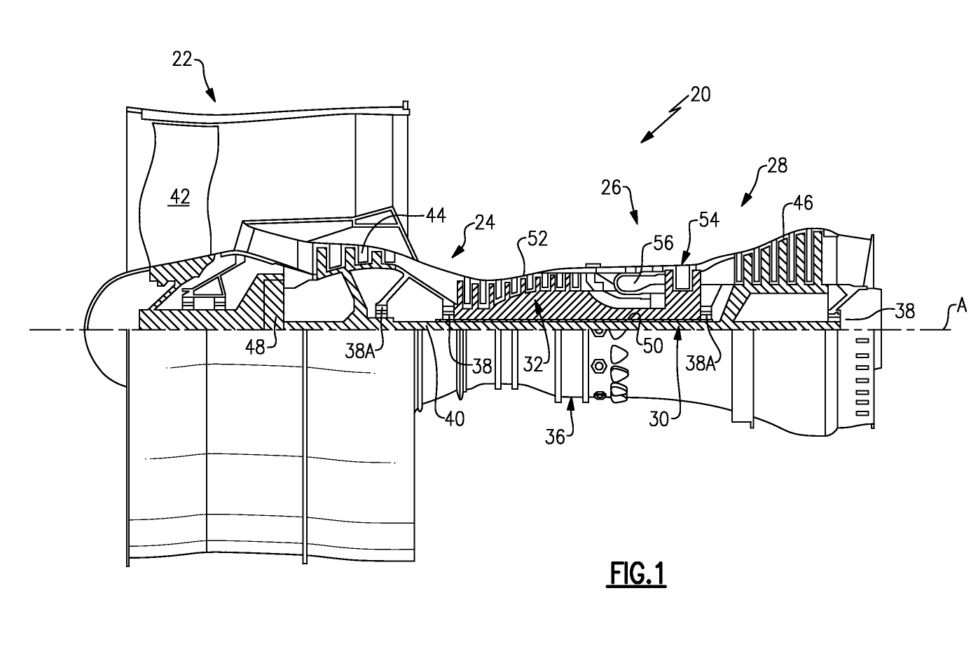

FIG. 1 schematically illustrates a gas turbine engine 20. The gas turbine engine 20 is disclosed herein as a two-spool turbofan that generally incorporates a fan section 22, a compressor section 24, a combustor section 26 and a turbine section 28. Alternative engines might include an augmentor section (not shown) among other systems or features. The fan section 22 drives air along a bypass flowpath while the compressor section 24 drives air along a core flowpath for compression and communication into the combustor section 26 then expansion through the turbine section 28. Although depicted as a turbofan gas turbine engine in the disclosed non-limiting embodiment, it should be understood that the concepts described herein are not limited to use with turbofans as the teachings may be applied to other types of turbine engines.

The engine 20 generally includes a low speed spool 30 and a high speed spool 32 mounted for rotation about an engine central longitudinal axis A relative to an engine static structure 36 via several bearing systems 38. The low speed spool 30 generally includes an inner shaft 40 that interconnects a fan 42, a low pressure compressor 44 and a low pressure turbine 46. The inner shaft 40 may drive the fan 42 either directly or through a geared architecture 48 to drive the fan 42 at a lower speed than the low speed spool 30. The high speed spool 32 includes an outer shaft 50 that interconnects a high pressure compressor 52 and high pressure turbine 54. A combustor 56 is arranged between the high pressure compressor 52 and the high pressure turbine 54. The inner shaft 40 and the outer shaft 50 are concentric and rotate about the engine central longitudinal axis A which is collinear with their longitudinal axes.

Core airflow is compressed by the low pressure compressor 44 then the high pressure compressor 52, mixed with the fuel in the combustor 56, then expanded over the high pressure turbine 54 and low pressure turbine 46. The turbines 54, 46 rotationally drive the respective low speed spool 30 and high speed spool 32 in response to the expansion.

The main engine shafts 40, 50 are supported at a plurality of points by the bearing system 38 within the static structure 36. In one non-limiting embodiment, bearing system 38 includes a number two bearing system 38A located within the compressor section 24.

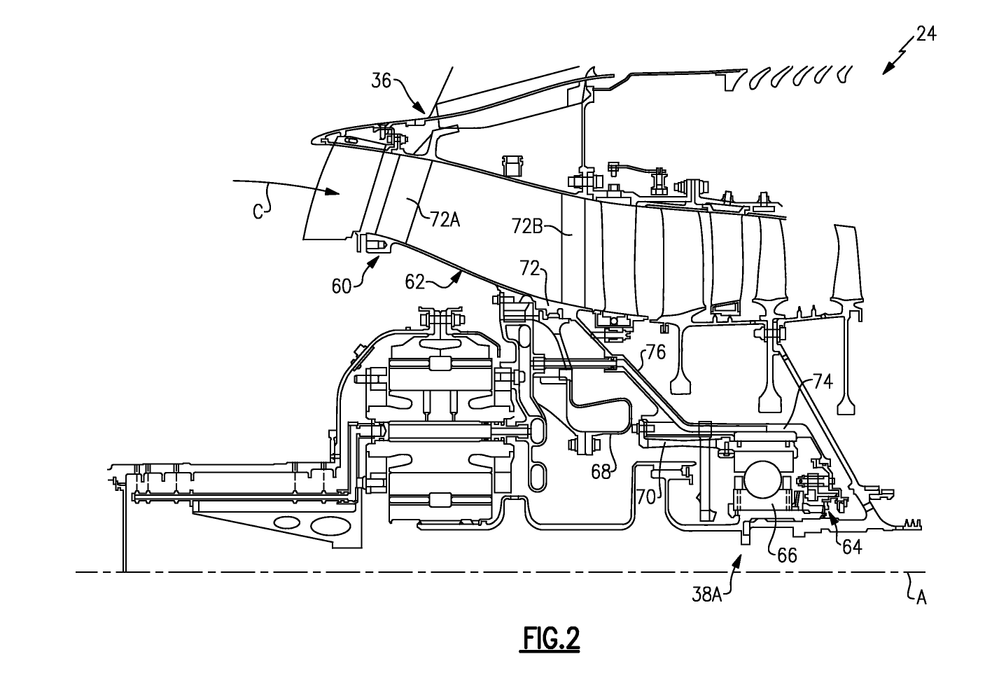

With reference to FIG. 2, the engine static structure 36 proximate the compressor section 24 includes a front center body assembly 60. The front center body assembly 60 generally includes a front center body support 62, a seal package 64, a bearing package 66 of the number two bearing system 38A, a flex support 68 and a centering spring 70.

The flex support 68 is a generally cylindrical structure which provides a flexible attachment of the geared architecture 48 within the front center body support 62. That is, the flex support 68 reacts the torsional loads from the geared architecture 48 and facilitates vibration absorption as well as other support functions.

The centering spring 70 is a generally cylindrical cage-like structural component with a multiple of beams which extend between flange end structures. The centering spring 70 facilitates a resilient position of the bearing package 66 with respect to the low speed spool 30. In one embodiment, the beams are double-tapered beams arrayed circumferentially to control a radial spring rate that may be selected based on a plurality of considerations including, but not limited to, bearing loading, bearing life, rotor dynamics, and rotor deflection considerations.

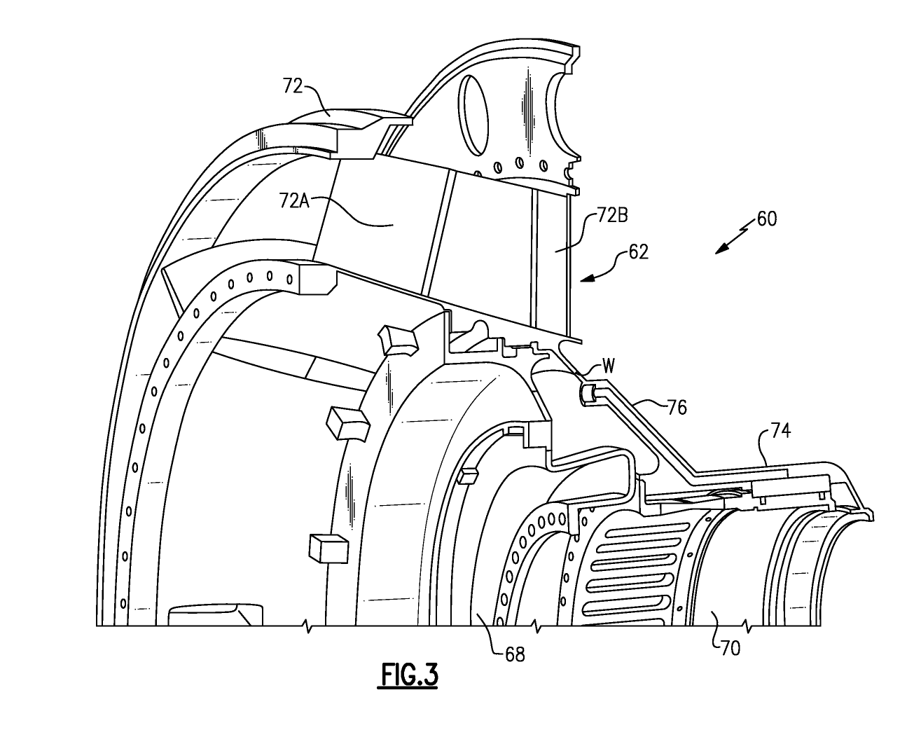

The front center body support 62 includes a front center body section 72 and a bearing section 74 defined about axis A with a frustro-conical interface section 76 therebetween. The front center body section 72 at least partially defines the core flowpath into the low pressure compressor 44. That is the front center body section 72 includes an annular passage with a multiple of front center body vanes 72A, 72B (FIG. 3).

The bearing section 74 is defined radially inward of the front center body section 72. The bearing section 74 locates the bearing package 66 and the seal package 64 relative to the low speed spool 30.

The frustro-conical interface section 76 combines the front center body section 72 and the bearing section 74 to form a unified load path, free of kinks typical of a conventional flange joint, from the bearing package 66 to the outer periphery of the engine static structure 36. The frustro-conical interface section 76 may include a weld W or, alternatively, be an integral section such that the front center body support 62 is a unitary component. The integral, flange-less arrangement of the frustro-conical interface section 76 facilitates a light weight, reduced part count arrangement with an increased ability to tune the overall stiffness to achieve rotor dynamic requirements. Such an arrangement also further integrates functions such as oil and air delivery within the bearing compartment which surrounds bearing package 66.

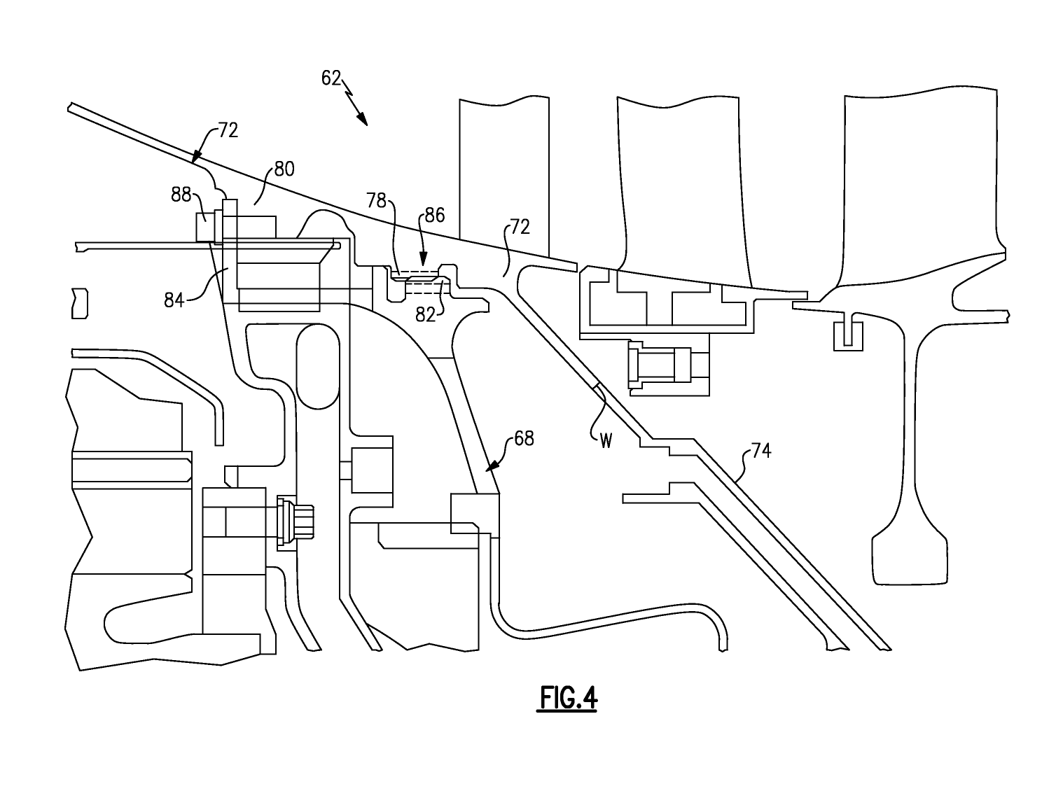

With reference to FIG. 4, the front center body support 62 also includes mount features to receive the flex support 68. In one disclosed non-limiting embodiment, the mount features of the front center body support 62 includes an internal spline 78 and a radial inward directed fastener flange 80 on the front center body section 72. The flex support 68 includes a corresponding outer spline 82 and radially outwardly directed fastener flange 84. The flex support 68 is received into the front center body support 62 at a splined interface 86 formed by splines 78, 82 and retained therein such that fastener flange 84 abuts fastener flange 80. A set of fasteners 88 such as bolts are then threaded into the fastener flange 80 to mount the flex support 68 within the front center body support 62.

The arrangement locates the fasteners 88 to provide access from a forward section of the front center body assembly 60 opposite the bearing package 66 of the number two bearing system 38A which facilitates assembly and disassembly.

It should be understood that like reference numerals identify corresponding or similar elements throughout the several drawings. It should also be understood that although a particular component arrangement is disclosed in the illustrated embodiment, other arrangements will benefit herefrom.

Although particular step sequences are shown, described, and claimed, it should be understood that steps may be performed in any order, separated or combined unless otherwise indicated and will still benefit from the present invention.

The foregoing description is exemplary rather than defined by the limitations within. Various non-limiting embodiments are disclosed herein, however, one of ordinary skill in the art would recognize that various modifications and variations in light of the above teachings will fall within the scope of the appended claims. It is therefore to be understood that within the scope of the appended claims, the invention may be practiced other than as specifically described. For that reason the appended claims should be studied to determine true scope and content.

1. A method for maintaining a gas turbine engine comprising:
providing access from a forward section of a front center body assembly to a flex support mounted to a front center body support, the flex support mounted to a geared architecture.

2. The method as recited in claim 1, further comprising:
interconnecting a fan of the gas turbine engine to the geared architecture.

3. The method as recited in claim 2, further comprising:
disassembling the geared architecture and the fan as a unit.

4. The method as recited in claim 3, further comprising:
removing a multiple of fasteners located from the front center body assembly through the forward section.

5. The method as recited in claim 4, further comprising:
locating the multiple of fasteners to provide access from the forward section of the front center body assembly opposite a bearing package.

6. The method as recited in claim 2, further comprising:
assembling the geared architecture and the fan as a unit.

7. The method as recited in claim 6, further comprising:
inserting a multiple of fasteners into the front center body assembly through the forward section.

8. The method as recited in claim 7, further comprising:
assembling the multiple of fasteners to a fastener flange of the flex support and a front center body section of the front center body support.

9. The method as recited in claim 1, further comprising:
locating the flex support at least partially within the front center body support at a splined interface.

10. A method for assembling a gas turbine engine comprising:
mounting a flex support within a front center body support.

11. The method as recited in claim 10, further comprising:
welding a front center body section and to a bearing section at a frustro-conical interface section.

12. The method as recited in claim 10, further comprising:
mounting a geared architecture to the flex support.
